(19) United States
(12) Patent Application Publication
(10) Pub. No.: US 2017/0269949 A1
(43) Pub. Date: Sep. 21, 2017

(54) METHOD AND DEVICE FOR OPERATING A CONTROL UNIT

(71) Applicant: Robert Bosch GmbH, Stuttgart (DE)

(72) Inventors: Jens Berg, Kornwestheim (DE); Stefan Gaab, Ludwigsburg (DE)

(21) Appl. No.: 15/463,038

(22) Filed: Mar. 20, 2017

(30) Foreign Application Priority Data
Mar. 21, 2016 (DE) 102016204598.9

(51) Int. Cl. G06F 9/455; G06F 11/36

(52) U.S. Cl. CPC G06F 9/455; G06F 11/3696

(57) ABSTRACT

A method and a device for operating a control unit which encompasses at least one register. A bypass for at least one specifiable register is provided for modifying a value in the machine code of the control unit that is stored in the register, by which bypass direct access is made to a specified register, and a value stored in the register is modified with the aid of the bypass by a software tool from outside the control unit.

### CROSS REFERENCE

The present application claims the benefit under 35 U.S.C. §119 of German Patent Application No. DE 102016204598.9 filed on Mar. 21, 2016, which is expressly incorporated herein by reference in its entirety.

### BACKGROUND INFORMATION

To test and protect a desired functionality or to assist in the development of software for control units, hardware-in-the-loop tests (HiL) are used, in particular in the case of embedded systems. In these real-time test systems, inputs and outputs of the control unit to be tested are connected to a real-time simulator, which then models the system to be controlled, such as an inverter or a vehicle, in a way that resembles reality as closely as possible.

The linking of the one control unit is normally realized via regular electrical paths. The inputs of the real-time simulator are the analog and digital control signals that are generated by the control unit.

The outputs of the real-time simulator are the digital and analog voltages that are read in by the control unit in order to detect the system status to be controlled.

Generally, the HiL method is cost-effective in comparison with real systems and grants a high degree of flexibility. However, expensive hardware in the form of hardware connections and input and output stages is nevertheless required.

To reduce the cost of the test equipment, it is possible to use what is known as software-in-the-loop or function-in-the-loop (FiL) technology as an alternative or in addition to the HiL systems. In this case, the real electrical connections are bypassed in that a memory of the control unit is read out and modified directly.

What are termed bypasses are normally used for variables in function-in-the-loop tests. This makes it possible to break open certain signal paths and to manipulate corresponding variables from the outside. In the case of complex control-unit functionalities, however, it is difficult and unmanageable to read out and modify a bypass for all relevant variables.

### SUMMARY

The present invention provides a method and a corresponding device, by way of which the signal path is modified at the lower-most function level, i.e., the register level.

A value is advantageously read out from a specifiable register of an analog-to-digital converter of the control unit or a value is written into a specifiable register of an analog-to-digital converter.

A value from a specifiable register of a digital-to-analog converter of the control unit is advantageously read out from a specifiable register or is written into a specifiable register of a digital-to-analog converter.

A register into which writing takes place is advantageously specified, which is read out for the purpose of ascertaining the values of a plurality of variables. The direct writing to the register that is relevant for a plurality of variables makes it possible to ensure that all variables contain the same desired setpoint value.

Advantageous further refinements are described herein.

The present invention is explained below with reference to the figure.

### BRIEF DESCRIPTION OF THE DRAWING

FIG. 1 shows schematically a portion of a test system.

### DETAILED DESCRIPTION OF EXAMPLE EMBODIMENTS

Test system 100 includes a simulation-modeling unit 102 and a control unit 104.

Registers 110 in which control-unit quantities are stored are provided in control unit 104. Registers 110 are addressed like a random access memory (RAM) cell. The addressing of RAM cells is known and will not be described further in this document.

Control unit 104 includes an electrical input 106, e.g., an analog-to-digital converter. Control unit 104 includes an electrical output 108 such as a digital-to-analog converter.

A memory 112 for variables is provided in control unit 104. The variables are ascertained, for example, from one or more value(s), which is/are stored in one of registers 110.

A function software 114 reads out the variables from memory 112 and ascertains an output quantity, which is output via electrical output 108.

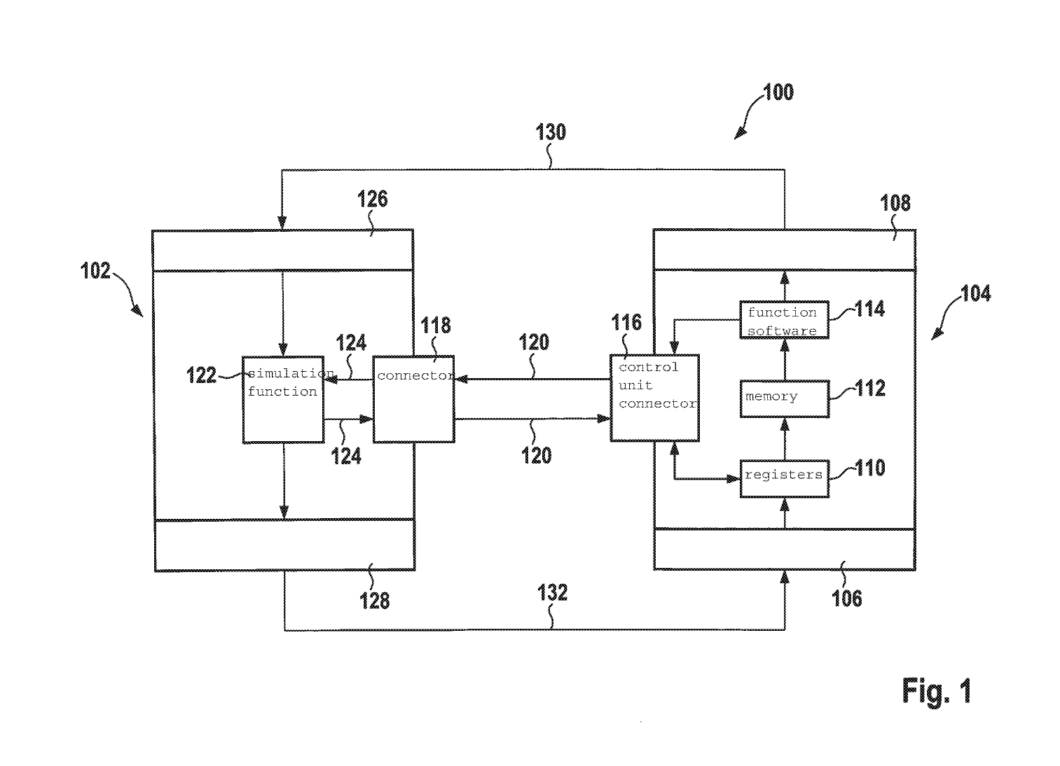

This creates a signal path in control unit 104 from electrical input 106, by way of at least one register 110, at least one variable from memory 112, the function software 114, and electrical output 108. This signal path is indicated by arrows in FIG. 1, which connect the aforementioned elements of control unit 104.

Here, a register 110 involves a processor register, for example. A microprocessor is preferably used, which encompasses at least one processor, a volatile or non-volatile memory 112, a function-software unit 114, and at least one register 110.

In addition, control unit 104 includes a control unit connector 116, such as a controller area network plug-in connector. Control-unit connector 116 is connected to function software 114 and to the at least one register 110. This is indicated by the arrows in FIG. 1, which connect the aforementioned elements. A software tool, which will be described in the following text, is provided to read out the at least one register 110 or to read out an output value of function software 114, or to write into the at least one register 110; the software tool is able to access control unit 104 via control-unit connector 116 for this purpose. To do so, control unit 104 is connectable via control-unit connector 116 to simulation-modeling unit 102, such as by means of a controller area network connection.

For example, simulation-modeling unit 102 includes a corresponding connector 118. In this way a data exchange is able to take place by way of a data link 120.

Simulation-modeling unit 102 includes a simulation function 122, which is connected to connector 118 via a data line 124. The simulation function, for example, simulates the “reality” for control unit 104.

In addition, simulation-modeling unit 102 includes an electrical input 126, such as an analog-to-digital converter, and an electrical output 128, such as a digital-to-analog converter.

They are connected to simulation function 122 via respective data lines, which are shown in FIG. 1 in the form of arrows that connect the aforementioned elements.

Output 108 of control unit 104 is connected via a line 130 to input 126 of simulation-modeling unit 102. Usually, line 130 is an electrical line via which the information is able to be transmitted by a signal. Hereinafter, line 130 is also referred to as data line 130.

Output 128 of simulation-modeling unit 102 is connected to input 106 of control unit 104 by way of a data line 132.

These data lines are preferably analog lines. With the aid of the method described hereinafter, the number of data lines required for testing of control unit 104 is at least able to be reduced. The number of the digital-to-analog outputs in system 100, which likewise cause expense, is reduced as well.

Via the software tool, e.g., the software tool EHOOKS of the ETAS GmbH, it is possible to set up a bypass for an existing control-unit quantity, such as a variable. Memory locations in memory 112 for the variables are specified when function software 114 is created. Because of the bypass, the value of the variable in the control unit is also available for read and write accesses from outside the control unit.

Depending on the bypass, i.e., external bypass or calibration bypass, a new RAM cell is set up in control unit 104 or an existing variable is cut free. In this context, cut free means that an existing RAM cell that contains a value of a variable is made available for a read or write access.

The new RAM cell or the existing RAM cell is overwritten with a specified value. This creates a new control-unit quantity or modifies an existing control-unit quantity.

An A2L data file that matches memory 112, in particular the RAM cells, is allocated to control unit 104. The A2L data file includes the information about the memory location, in particular the RAM cell, of a control-unit quantity. A2L write data files for control-unit-internal quantities are known and will not be described in greater detail here.

By modifying the A2L data file, a bypass is also described for at least one register 110. In the process, the addresses of one or more register(s) 110 are added to the A2L data file. This makes information about the registers available to the software tool. The software tool modifies the machine code of control unit 104 as a function of the modified A2L data file in such a way that a bypass is inserted for a register 110. Direct access takes place to register 110 through the bypass in the machine code of the control unit. This means that the signal path is broken open for the modification of register values. Using the software tool, this bypass is able to be inserted without more detailed knowledge of the other code of function software 114, e.g., without more detailed knowledge of variable definitions in function software 114. In this way direct access to the at least one register 110 takes place.

A value, for example from a specifiable register 110 of an analog-to-digital converter or a digital-to-analog converter of the control unit, is read out by the direct access to register 110.

Through the direct access, for example, a specifiable value is written into a specifiable register 110 of an analog-to-digital converter or into a digital-to-analog converter of the control unit.

If a register 110 is specified for the writing that is read out in order to ascertain the values of a plurality of variables, the direct writing into register 110 relevant for the plurality of variables results in all variables receiving the same desired setpoint value, i.e. without requiring a bypass for each one of the variables.

The difference from a conventional bypass is that instead of a plurality of bypasses for each one of the variables individually, all variables are reliably modified by a single write access to corresponding register 110.

Registers 110 are advantageously read out by software functions from function software 114 for ascertaining the variables in memory 112. The modified value of the register thereby makes its way into the software functions without any need to modify something in the software function itself.

The described method has the following advantages:

The signal path is cut free at the lowest level, which in this particular case is formed by the registers.

The same value is used in the variables that are based on the register value.

All variables based on a register value are treated uniformly and simultaneously, which makes for better serviceability and clarity.

The HiL hardware equipment is reduced in comparison with conventional systems, which offers advantages in terms of expense, time and space.

Increases in the efficiency and flexibility of the testing possibilities, such as real prototyping, result during the software and function development.

Electrical hardware connections to test-control unit 104 are able to be replaced by the software paths. This results in cost and space advantages, and time is also saved when setting up the HiL system.

This means that control unit 104 is connected to a hardware-in-the-loop test system or to a function-in-the-loop test system by way of at least one data line.

What is claimed is:

1. A method for operating a control unit that includes at least one register, the method comprising:
providing a bypass for at least one specifiable register for modifying a value in a machine code of the control unit stored in the register, through which direct access is made to a specified register, a value stored in the register being modified with the aid of the bypass by a software tool from outside the control unit.

2. The method as recited in claim 1, wherein the control unit includes an analog-to-digital converter, the at least one specifiable register is a register of the analog-to-digital converter, and a value is one of: i) read out from the register of the analog-to-digital converter of the control unit, or, ii) is written into the register of the analog-to-digital converter.

3. The method as recited in claim 1, wherein the control unit includes a digital-to-analog converter, the at least one specifiable register is a register of the digital-to-analog converter, and a value is one of: i) read out from the register of the digital-to-analog converter of the control unit, or ii) is written into the register of the digital-to-analog converter.

4. The method as recited in claim 1, wherein the specifiable register is specified for writing, and is read out for ascertaining values of a plurality of variables.

5. The method as recited in claim 1, wherein the control unit is connected by way of at least one data line to a hardware-in-the-loop test system or to a function-in-the-loop test system.

6. The method as recited in claim 1, wherein the specifiable register is a random access memory cell.

7. The method as recited in claim 1, wherein an address in the memory of the control unit is found with the aid of the software tool, the software tool reading an item of information about the address from a data file and modifying the machine code of the control unit in such a way that the bypass is created.

8. The method as recited in claim 1, wherein the software tool accesses the register directly.

9. A device for operating a control unit that includes at least one register, the device configured to provide a bypass for at least one specifiable register for modifying a value in a machine code of the control unit stored in the register, through which direct access is made to a specified register, a value stored in the register being modified with the aid of the bypass by a software tool from outside the control unit.

10. A non-transitory computer readable storage medium on which is stored a computer program for operating a control unit that includes at least one register, the computer program, when executed on a processor, causing the processor to perform:
providing a bypass for at least one specifiable register for modifying a value in a machine code of the control unit stored in the register, through which direct access is made to a specified register, a value stored in the register being modified with the aid of the bypass by a software tool from outside the control unit.
